(19) United States
(12) Patent Application Publication
(10) Pub. No.: US 2007/0070377 A1
(43) Pub. Date: Mar. 29, 2007

(54) Image forming apparatus and image forming method

(75) Inventor: Kazunori Hirabayashi, Izunokuni-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/234,371

(22) Filed: Sep. 22, 2005

(51) Int. Cl. G06F 3/12

(52) U.S. Cl. 358/1.13; 358/1.15

(57) ABSTRACT

In contrast to conventional art in which settings for a printer driver of a personal computer are changed, and printing is carried out by preparing a PDL file again and transmitting the file, according to the present invention, an image output is obtained due to print settings being carried out in a printer controller of a printer in advance, and by preparing an image onto which a plurality of settings have been reflected. PDL files serving as bases for the settings are temporarily stored in a hard disk device, and in a case of reprinting, additionally outputting, or the like, printing is carried out instantly without repeating the same operations from the personal computer. Due to color adjustment settings (for photo, for graphics) and the like being set in a storage area in the hard disk device, a desired printed matter is selected while confirming an output result without carrying out settings from the printer driver of the personal computer at the user side.

### BACKGROUND OF THE INVENTION

1. Field of the Invention

The present invention relates to an image forming method of an image forming apparatus which is connected to a personal computer via a communication line, and which forms an image.

2. Description of the Related Art

Conventionally, when a PDL file transmitted via a network from a personal computer is received, an electrophotographic color printer or a digital multi-function peripheral (MFP) interprets the PDL file and converts it by a printer controller RIP into a format recognizable to a printer engine.

On a personal computer (PC), prepared application data are prepared as page description language files (PDL: PostScript3, PCL, and the like) recognizable to an object printer, and the PDL files are transmitted to the MFP via a communication medium such as a network or the like. Note that the MFP is composed of an integrated combination of copy, scan, and print functions.

An output image of a printer is generally formed from the components of C (cyan), M (magenta), Y (yellow), and B (black).

Usually, a printer has functions specific to the machine, and various settings can be applied on a printer driver. These are, for example, setting for a number of copies, paper type, paper size, color setting for printing photo, setting for printing graphics, change of screen, and the like.

In conventional printing, when a number of copies is changed, or a printing paper is changed, with respect to application data prepared on a PC, it is necessary that the application data is opened on the PC, object data is loaded, a printer driver is called, print settings are changed, and a PDL file is prepared and transmitted to a printer to print. When the output result does not meet a requirement, it is necessary to repeat the same operations.

In order to reduce such troublesome matters, and to efficiently reprint the printing, a method has been known in which a final image prepared in a printer is automatically reserved in the printer, and the reserved image is output by issuing an instruction to utilize it as is.

Further, a method has been known in which a PDL file is automatically stored in a hard disk device of the printer, and the data image is output by issuing an instruction to utilize it as is.

Further, there is a method as well in which a PDL file is automatically stored in a hard disk device of a printer, and reprinting is efficiently carried out by changing the print settings for the data.

With respect to printers, MFPS, or the like, in order to reduce the bother that reprinting is carried out from a PC, there is a method in which an image or a PDL file is reserved in a printer or a MFP, print settings (specification for a number of copies, paper specification) are changed with respect to the PDL file. However, the method is for changes of a number of copies or printing paper.

However, other settings (various settings such as color adjustment setting for printing photos, water mark setting, screen setting, and the like) which can be specified by a printer driver have not been considered.

When an image is stored as an output image, it is necessary for a user to set as “Save” in advance, which is troublesome.

Conventionally, when coloring of an actual printed image is unacceptable, or an actual printed image is different from an assumed output format, it is necessary to open an application from PC, and to print it by a printing instruction. When a result is not made desirable even if changes have been made, it is necessary to repeat such operations. At that time, there is a problem as well that the printed matter for a testing purpose falls into disuse.

Further, items set on a printer driver and setting methods are extremely complicated, and knowledge and time are required for obtaining a desired printed matter by setting one by one, and the burden on a user is extremely large. In some cases, functions of an output device cannot be sufficiently used because of the lack of knowledge in a setting method.

### BRIEF SUMMARY OF THE INVENTION

The object of an aspect of the present invention is to provide an image forming method of an image forming apparatus which reduces troublesome work operations and unnecessary outputs.

According to an aspect of the present invention, there is provided an image forming method of an image forming apparatus which forms an image of data received via a communication line including: storing the data received via the communication line into dedicated storage areas; setting a plurality of image forming conditions for said each dedicated storage area; changing the data stored in the dedicated storage areas by using the set image forming conditions; generating image information based on the changed data, and storing the image information into the dedicated storage areas; displaying a list of the image information stored in the dedicated storage areas; selecting one image information from the displayed image information list; forming an image by reading the selected image information from the dedicated storage areas; and deleting the data and the image information in the dedicated storage areas under a condition set in advance.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram showing a system structure to which a printer relating to an image forming method of the present invention is connected;

FIG. 2 is a flowchart for explanation of operations of a first embodiment;

FIG. 3 is a flowchart showing a procedure for carrying out settings onto a storage area for a user;

FIG. 4 is a diagram showing an example of sets of print settings set on the storage area for each user;

FIG. 5 is a flowchart showing an example of operation setting for deleting files in the storage area;

FIG. 6 is a diagram showing a display example;

FIG. 7 is a flowchart showing operations of a second embodiment;

FIG. 8 is a flowchart for explanation of operations of a third embodiment; and

FIG. 9 is a flowchart showing operations of a fourth embodiment.

### DETAILED DESCRIPTION OF THE INVENTION

Hereinafter, an embodiment of the present invention will be described with reference to the drawings.

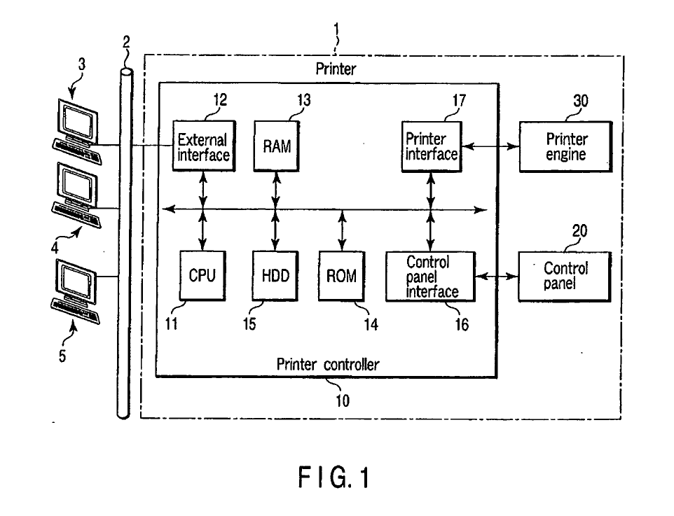

FIG. 1 shows a system structure to which a printer relating to an image forming method of the present invention is connected. This system is structured such that a printer 1 is connected to personal computers (PCs) 3, 4, and 5 via a network 2.

The printer 1 is structured with a printer controller 10, a control panel 20 having a display device (not illustrated), and a printer engine 30.

The printer controller 10 is structured with a CPU 11 which manages the entire control, an external interface 12 for connecting to the network 2, a RAM 13 which temporarily stores data, a ROM 14 in which programs or the like are stored, a hard disk device (HDD) 15, a control panel interface 16 connected to the control panel 20, and a printer interface 17 connected to the printer engine 30.

PCs 3, 4, and 5 respectively have printer drivers (not illustrated), prepare PDL files, and transmit those to the printer 1.

Next, in such a structure, a first embodiment will be described.

First, a user opens application software on the PC 3 and reads out data to be printed. The user carries out various print settings of the data by using the printer driver in the PC 3. This printer driver prepares a PDL file at the stage in which one set of settings is determined. This prepared PDL file is transmitted to the inside of the printer controller 10 via the network 2 and the external interface 12 of the printer 1.

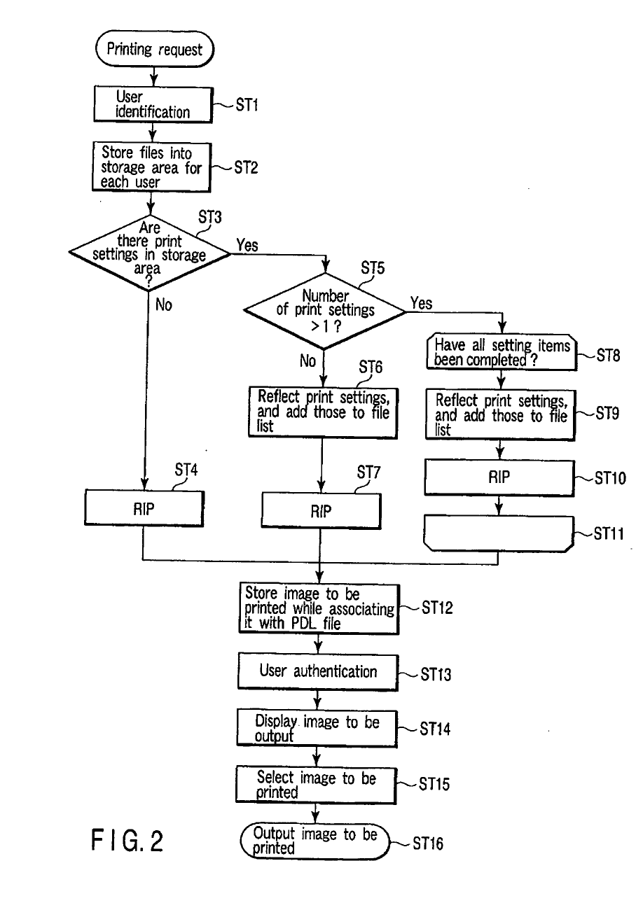

Here, operations of the first embodiment will be described with reference to the flowchart of FIG. 2.

The CPU 11 of the printer controller 10 acquires a user name, a client name, and the like as user information (ST1) at the time of receiving the PDL file, and stores (reserves) the PDL file in a storage area, which is provided to the HDD 15 and exclusive to the user (ST 2). With respect to identification of a user, the identification may be carried out based on the user information under the management of the printer 1 main body and the information in the PCs (3, 4, and 5) of the clients, or an external certificate server or the like may be used.

Further, in the storage area, which is provided to the HDD 15 and exclusive to the user, it is possible to store a plurality of sets of print settings (print settings recognizable to the printer main body) in advance.

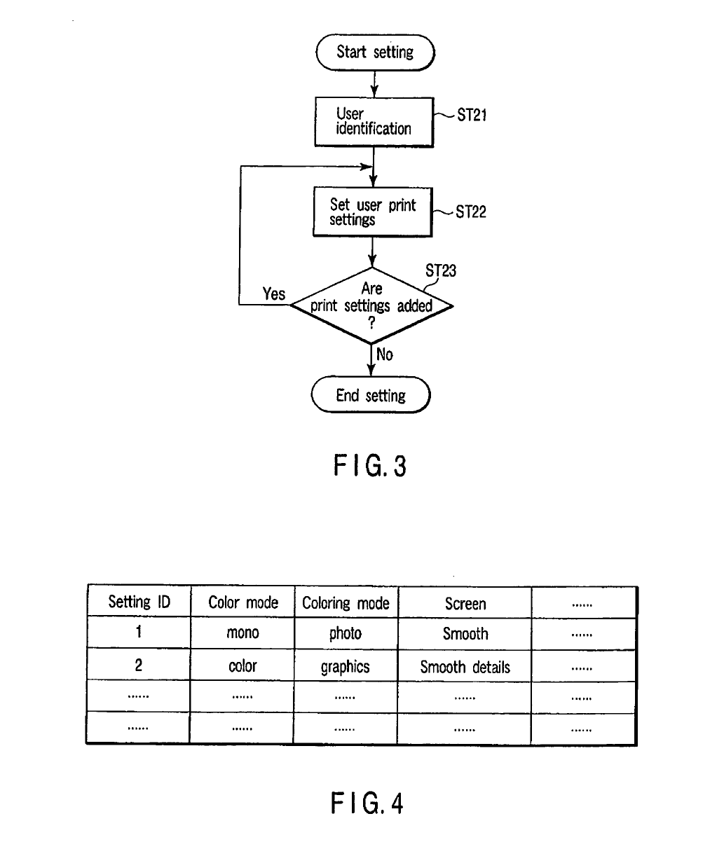

The flowchart of FIG. 3 shows a procedure for carrying out settings onto the storage area for a user provided to the HDD 15. For example, when the printer 1 is a color machine, setting for limiting outputs to be black-and-white, setting for the printer according to data to be printed in a plurality of image adjustment modes (photo mode, graphics mode, and the like), setting for arranging a plurality of pages into one sheet, or the like are carried out (ST21 to ST23). Settings for punching, stapling, both side printing, or the like are carried out.

Further, sets of print settings onto which a plurality of print settings (for example, sets of print settings, such as black-and-white+color setting for photo+stapling, color+color setting for graphics, and the like, which can be set on the driver) have been applied may be combined.

FIG. 4 shows setting examples of print settings set on the storage areas for each user. For example, in a case of setting ID 1, the color mode is “mono”, and the coloring mode is “photo”, and the screen is “smooth”.

Further, conditions for deleting PDL files stored in the storage area and output images (in forms which can be immediately interpreted by the printer engine 30) can be set in the storage area exclusive to the user provided to the HDD 15. As conditions for deletion, a condition under which the PDL file is deleted in accordance with an elapsed time (after one minute, after 10 minutes, one day, or the like) after a PDL file is received, setting for deletion immediately after printing is completed, FIFO (first in first out: a system in which stored data are taken out in order of the length of storing time, and latest stored data is taken out at the last), or the like can be set.

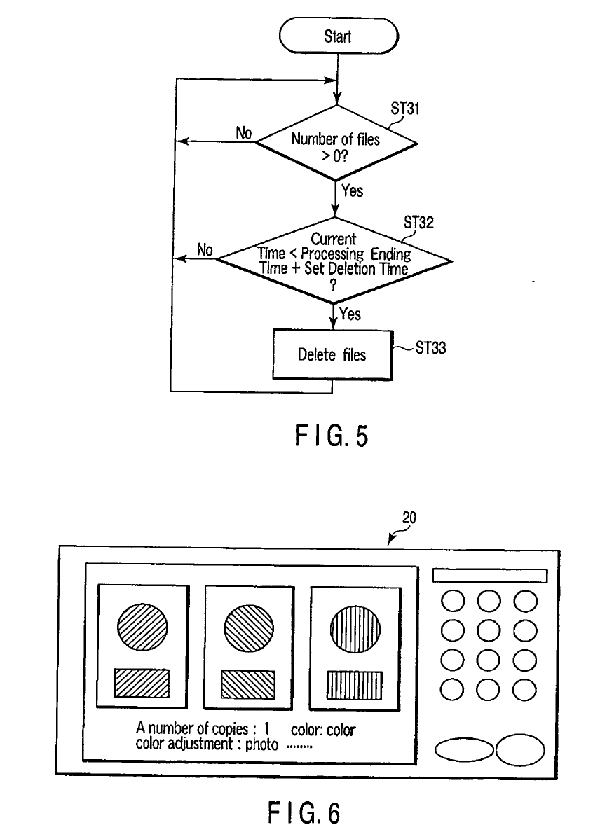

A flowchart of FIG. 5 shows an example of operation setting for deleting files in the storage area provided to the HDD 15. Namely, when there are files in the storage area provided to the HDD 15, the files are deleted when Current Time<Processing Ending Time+Set Deletion Time is satisfied.

Then, in step ST3, when there are no print settings in the storage area, the CPU 11 merely follows the print settings specified by the printer driver (ST4).

Further, in step ST3, when there are print settings in advance in the storage area exclusive to the user provided to the HDD 15, the CPU 11 generates a PDL file set by the print settings which have been set with respect to the storage area provided to the HDD 15 (ST5-11).

As a method of resetting, when there are overlapping setting items in an object PDL file, the setting items are overwritten onto the PDL file. When setting items are newly set onto a PDL file without any previous setting item, a description is written additionally into the file in a format recognizable to the printer 1 main body (RIP [Raster Image Processor]: a program for analyzing a PDL file and rasterize it, which is usually stored in the HDD 15, the ROM 14, or the like, and is loaded into the RAM 13 as needed, and is operated on the CPU 11).

When there are a plurality of print settings, the respective print settings are reflected thereto before the PDL files are delivered to the RIP (Raster Image Processor). At that time, changed data are stored by utilizing differences in the changed PDL files.

Thereafter, all the PDL files which are objects to be printed are transmitted to the RIP. The RIP generates (rasterizes) an image onto which the print settings have been reflected in a format (CMYK) recognizable to the printer engine 30.

The images converted into the format recognizable to the printer engine 30 are once stored in the HDD 15 while being associated with the PDL files whose settings have been changed (ST12).

The user carries out user authentication from the control panel 20 (ST13), and the CPU 11 thereby lists the images in the storage area for the user provided to the HDD 15, and displays the list on an image display device such as the control panel 20, an external large-screen display (not illustrated), or the like (ST14). Note that, for the user authentication, a personal identification number, biometrics such as fingerprint authentication, and the like are used.

When there are a plurality of images, the images, classified for each PDL file, are displayed.

The list display at that time is in thumbnails of the images, and the images are generated so as to duplicate the outputs of the printer 1. Because the thumbnails are generated by utilizing the functions of the RIP, it is possible to duplicate the images while recognizing the characteristics that the printer engine 30 has.

Here, the user selects an image in a format that s/he prefers to print, from the displayed images.

FIG. 6 shows a display example thereof.

When an image to be output is selected, the CPU 11 of the printer controller 10 reads data corresponding to the selected image from the HDD 15, and transmits the data to the printer engine 30, and outputs the data at the printer engine 30 (ST16).

Because the image to be printed corresponding to the selected thumbnail image has been already generated (rasterized) at this point, a work operation for rerasterizing the PDL is not needed, and it is possible to print the image at high speed. In a case of reprinting as well, because the data has been already generated, it is possible to print the image at high speed.

Here, when the actual output image is not in a desired format or color, the user can select an image to be printed again from the list instantly.

Further, when a desired output image is not formed in accordance with the items which have been set in the storage area of the HDD 15 in advance, the user can change the print settings from the control panel 20. The items which can be set on the control panel 20 are in a format which is recognizable to the printer 1 main body.

When new print settings are set, the CPU 11 immediately generates output images by RIP, and the output images become selectable at the display device of the control panel 20. Here, when changed print settings are for a number of copies, punching, stapling, or the like, and an image is not newly generated by RIP (because there is no effect such as colors or the like on the image), printing is carried out by reutilizing the already generated image. This function can be turned on and off.

As described above, in accordance with the above-described first embodiment, print settings are carried out in advance in the printer controller, and an image onto which a plurality of settings have been reflected is prepared, which enables to obtain an image output without changing the settings of the driver, preparing a PDL file, and transmitting and printing the PDL file on the PC.

Because the PDL files serving as bases for settings are temporarily stored in the HDD, the PDL files can be printed on the moment without repeating same operations from the PC when reprinting, additional output, or the like is carried out.

By setting color adjustment setting (for photo, for graphics) and the like in advance with respect to the storage area of the HDD, it is possible for a user to select a desired printed matter while confirming the output result without bothering to carry out settings from the printer driver.

Next, a second embodiment will be described.

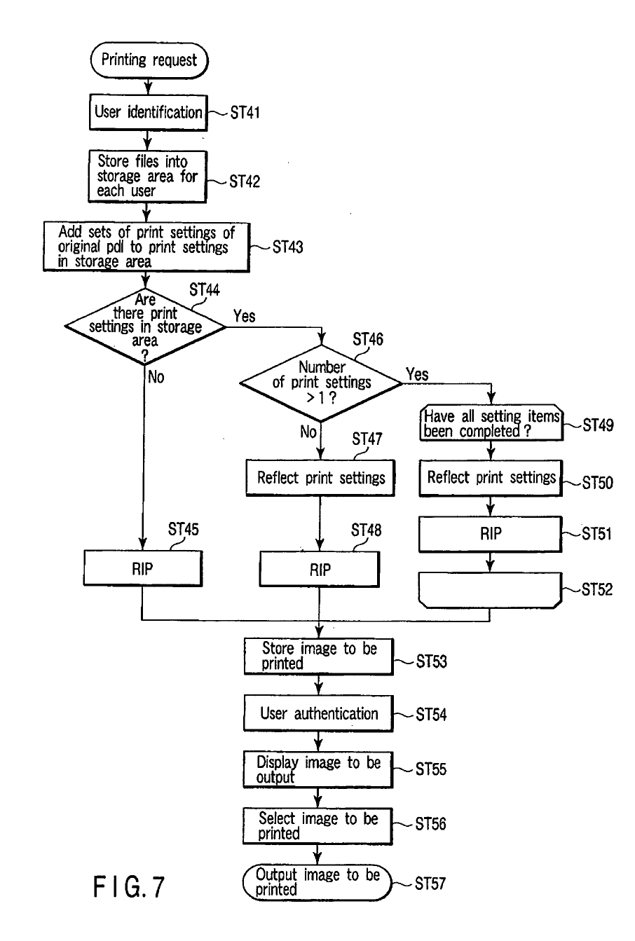

FIG. 7 is the flowchart showing operations of the second embodiment.

In the second embodiment, contrary to the first embodiment where a user sets print settings to be set in the storage area exclusive to the user on the printer 1, a CPU 11 stores sets of print settings for PDL files transmitted by the user in a HDD 15 (ST43). Here, a number of sets to be stored can be specified. A method for managing the settings to be stored may be a FIFO system, or settings more frequently used by the user may be listed.

Then, the CPU 11 reflects the print settings by using the sets of print settings stored in the HDD 15 (ST47, ST50).

Operations in steps except for steps ST43, ST47, and ST50 are the same as those in the first embodiment, and therefore, descriptions thereof will not be repeated.

As described above, in accordance with the second embodiment, it is possible to prepare an image onto which print settings set previously by the user have been reflected, at the time of printing.

Further, even when the user carries out incorrect print settings, because an image is prepared by the print settings set in the past, it is possible to reduce time and labor for settings required for the main body in advance.

Further, there is no need to prepare a PDL file by using the printer driver by the personal computer again, and efficient printing is possible.

Next, a third embodiment will be described.

First, at a PC 3, a user prepares a PDL file by using a printer driver from an application software, and issues a print job to transmit the PDL file to a printer 1.

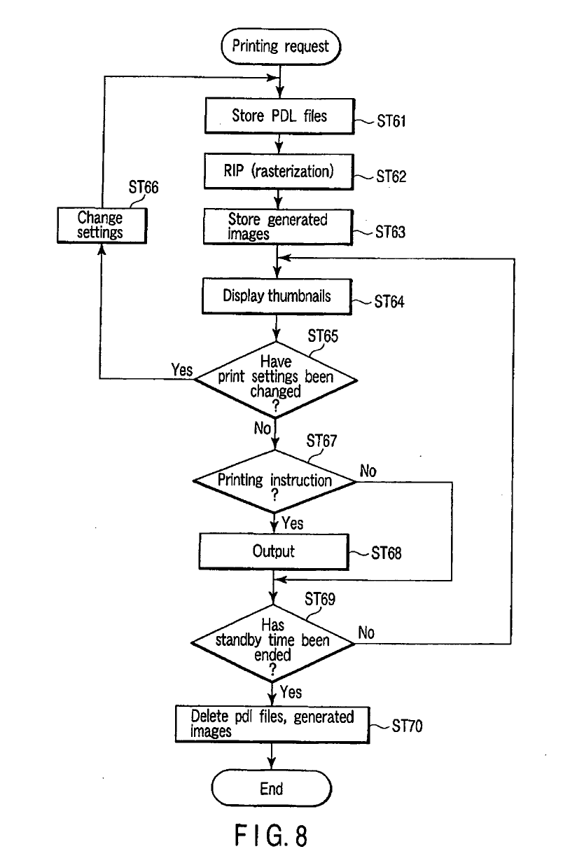

Here, operations of the third embodiment will be described with reference to the flowchart of FIG. 8.

A CPU 11 of a printer controller 10 stores (saves) the transmitted PDL file in a HDD 15 (ST61), and immediately rasterizes the stored PDL file (ST62), and stores the rasterized image in the HDD 15 (ST63). Note that the image may be stored in an external storage device connected externally.

With respect to a print job received from the PC 3, for example, by issuing a printing instruction after selecting an object job with reference to a list of jobs from the control panel 20 of the main body or by transmitting a printing instruction from a network 2 (ST67), actual printing is carried out (ST68).

During this time, while being on standby for only a standby time set at the printer 1 side (ST69), the CPU 11 deletes the stored PDL files and rendered images when the standby time passes (ST70).

When a printing instruction is input, the CPU 11 displays a thumbnail of an output image as a preview of the printing on a display device of the control panel 20, a display on the PC 3, and/or an external display.

Here, it is selected whether or not the print job is printed as is, or setting for changing coloring is set (setting for photo, setting for graphics, setting of screen, or the like) on the control panel 20 or via the network 2 (ST65).

In a case of changing print settings, the CPU 11 additionally writes to or edits the stored PDL files into a format recognizable to RIP, and prepares new PDL files (ST66). When the setting changes are completed, the changed PDL files are immediately rasterized, and the images are stored in the storage area, and are managed while being associated with corresponding PDL files.

Then, by an instruction from the user (ST67), the CPU 11 outputs a final printed matter (ST68).

The user confirms the final output (paper output or the like), and when the printed matter is different from one that the user has estimated, the user can change the settings, and instructs to reprint (ST65). When there are changes at the time of reprinting, the contents of the changes are reflected to the stored PDL files, and the changed PDL files are rasterized and output. In cases, for example, where there is no change, and when the user wishes to print the same image again, an image already rasterized is output.

As described above, in accordance with the above-described third embodiment, a rasterized image and a PDL file serving as a base are stored in the storage area at the time of printing, and an output can be confirmed on a display device before the outputting, and it is possible to suppress unnecessary outputs.

Further, when color adjustment setting (setting for photo, setting for graphics, or the like) is changed, because the PDL file serving as a base is stored, it is possible to rasterize, while immediately reflecting the contents of changes such as colors or the like, so that time and labor at the time of outputting again can be reduced.

Moreover, because the data are deleted after a certain time period, it is effective in a security aspect.

Next, a fourth embodiment will be described.

In the first, second, and third embodiments which are described above, the settings are reflected by modifying PDL files to prepare new PDL files.

In the fourth embodiment, management is separately carried out by using a file different from a PDL file, for example, a job ticket. A job ticket (printing instruction statement) is that settings such as a number of copies, paper, color space, color conversion system, finishing (punching, stapling), or the like are made independent from PDLs (PostScript, PCL, PDF, or the like), and are made to be files (metadata).

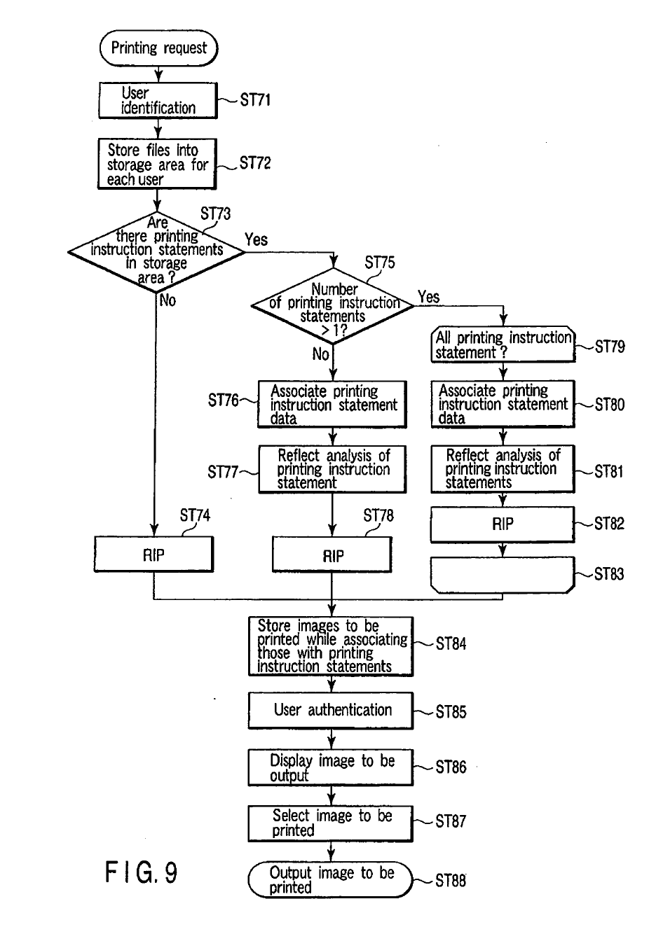

FIG. 9 is the flowchart showing operations of the fourth embodiment.

A job ticket is a file in which various settings such as a number of copies, specification for color, specification for both side printing, specification for paper feeding, specification for paper type, and the like are put together. Namely, a PDL file stored inside and a job ticket with corresponding settings are stored while being associated with one another (ST73).

This management may be carried out by a print controller 10, or a print server (not illustrated) on a network 2.

RIP that receives the PDL file recognizes the setting information of the associated job ticket, and carries out rasterization in accordance with the setting information (ST 76, ST77, and ST78) (ST 80, ST81, and ST82).

A format of the job ticket may be a standardized format (job definition format (JDF) or the like). Note that JDF is a standard aimed to be utilized for a printing workflow.

At the last, other embodiments will be described.

In the embodiment described above, the case in which the function for implementing the invention has been recorded inside a printer (apparatus) has been described. However, the present invention is not limited thereto. The same function may be downloaded into the printer (apparatus) from a network, and a recording medium on which the same function has been stored may be installed into a printer (apparatus).

Further, the same function may be provided on a personal computer other than the printer (apparatus).

As a recording medium, any form of recording media, such as CD-ROMs, can be used as long as a program can be stored, and read by the printer (apparatus).

Further, as the function obtained in advance by being installed or downloaded in this way, the function may be realized in cooperation with an operating system (OS) or the like inside a printer (apparatus).

As described above, in accordance with the above-described embodiments of the present invention, a plurality of sets of print settings are set in a printer main body by each user as print settings (settings such as color adjustment function and the like) set on a printer driver of a personal computer, and images are prepared based on all the print settings which have been set. Accordingly, time and labor for changing settings and then reprinting are reduced.

Further, because images onto which the print settings set in advance in a printer main body have been reflected have been already prepared in advance, it is possible to reprint images at high speed. For example, when a user prints a color original manuscript as a copy in black-and-white, and selects color printing by mistake on the printer driver of a personal computer, the two types of black-and-white and color are set in advance at the printer main body side, and images in black-and-white and color can be respectively generated. Conventionally, a color output is output as is, and it is necessary to reprint it from an application software in the personal computer.

In contrast thereto, by utilizing the present invention, an output can be confirmed before outputting it, and it is possible to avoid outputting by mistake. At that point in time, because images in black-and-white and color in a format recognizable to a printer engine are generated, it is possible to reprint an image that a user desires without causing stress to the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming method of an image forming apparatus which forms an image of data received via a communication line comprising:
storing the data received via the communication line into dedicated storage areas;
setting a plurality of image forming conditions for said each dedicated storage area;
changing the data stored in the dedicated storage areas by using the set image forming conditions;
generating image information based on the changed data, and storing the image information into the dedicated storage areas;
displaying a list of the image information stored in the dedicated storage areas;
selecting one image information from the displayed image information list;
forming an image by reading the selected image information from the dedicated storage areas; and
deleting the data and the image information in the dedicated storage areas under a condition set in advance.

2. An image forming method of an image forming apparatus which forms an image of data received via a communication line comprising:
identifying a source of request of the image forming request when an image forming request is received,
storing data transmitted in accordance with said each identified source of request into a dedicated storage area for said each source of request;
setting a plurality of image forming conditions onto the dedicated storage area for said each source of request;
changing data which are image forming objects stored in the dedicated storage area for said each source of request by using the image forming conditions set for said each source of request;
generating image information based on the changed data, and storing the image information into the dedicated storage area for said each source of request;
executing user authentication for the source of request at the time of forming an image of the image information stored in the dedicated storage area;
displaying a list of the image information stored in the dedicated storage area for the source of request authenticated by the user authentication when the source of request is authenticated by the user authentication;
selecting one image information from the displayed image information list;
forming an image by reading the selected image information from the dedicated storage area for the source of request; and
deleting the data and the image information in the dedicated storage areas under a condition set in advance.

3. An image forming method of an image forming apparatus which forms an image of data received via a communication line comprising:
identifying a source of request of an image forming request when the image forming request is received,
storing data transmitted for said each identified source of request into a dedicated storage area for said each source of request;
storing image forming conditions received via the communication line into the dedicated storage area for said each source of request;
changing data which are image forming objects stored in the dedicated storage area for said each source of request by using the image forming conditions stored in the dedicated storage area for said each source of request;
generating image information based on the changed data, and storing the image information into the dedicated storage area for said each source of request;
executing user authentication for the source of request at the time of forming an image based on the image information stored in the dedicated storage area;
displaying a list of the image information stored in the dedicated storage area for the source of request authenticated by the user authentication when the source of request is authenticated by the user authentication;
selecting one image information from the displayed image information list;
forming an image by reading the selected image information from the dedicated storage area for the source of request; and
deleting the data and the image information in the dedicated storage area under a condition set in advance.

4. The image forming method according to claims 1 to 3, wherein the data, the image forming conditions, and the generated image information which have been stored in the dedicated storage areas are managed while being associated with one another.

5. The image forming method according to claims 1 to 3, wherein the dedicated storage areas are storage areas in an image forming apparatus, or storage areas connected to a communication line.

6. The image forming method according to claims 1 to 3, wherein the data stored in the dedicated storage areas are PDL files.

7. The image forming method according to claims 1 to 3, wherein the condition, which has been set in advance, for deleting data and image information stored in the dedicated storage areas is a storage period during which the data and image are stored in the dedicated storage areas.

8. The image forming method according to claims 2 and 3, wherein, under the condition, which has been set in advance, for deleting the data and the image information stored in the dedicated storage area for said each source of request, the data and the image information stored in the dedicated storage area for said each source of request are deleted in order of the length of time elapsed.

9. The image forming method according to claims 2 and 3, wherein among the image forming conditions to be stored in the dedicated storage area for said each source of request, only a predetermined number of the image forming conditions are stored in order of the frequency of specifications by sources of request.

10. The image forming method according to claims 1 to 3, wherein the image forming conditions are settings for color adjustment parameters (coloring) for forming an image, settings for screen, and printing modes (color and black-and-white).

11. The image forming method according to claim 3, wherein the data and the image forming conditions are stored as separate files respectively into dedicated storage area for said each source of request, and are managed while being associated with one another.
